(19) United States
(12) Patent Application Publication
(10) Pub. No.: US 2007/0114187 A1
(43) Pub. Date: May 24, 2007

(54) Enhanced water removal from used lubricating oils (Pre-treatment of Used oils)

(76) Inventors: United Lube oil Company, Jubail Industrial City (SA); Abdullah Abdulrahman Al-Zahrani, Jubail Industrial City (SA)

Correspondence Address: UNITED LUBE OIL COMPANY, P.O. BOX NO. 11234, JUBAIL, 31961, SA

(21) Appl. No.: 11/164,256

(22) Filed: Nov. 16, 2005

(51) Int. Cl. C02F 1/00

(52) U.S. Cl. 210/767

(57) ABSTRACT

Unilube's “Enhanced water removal from used oils” is an in-house developed process and has been proven successful upon commissioning of Unilube's own ‘Pre-treatment unit’ using this technology in Dammam (Saudi Arabia). Unilube has its own refinery for recovery of Base oils (Vaxon Technology). The yield % of base oils (Ratio of base oil recovered to the actual feed consumed) has improved from 45% to 55% upon commissioning of this pre-treatment unit. Untreated used oil with average water of 20% is treated to obtain treated oil with less than 3% water. The plant process flow can handle dirty used oil with cost effective recovery systems incorporated in the basic design.

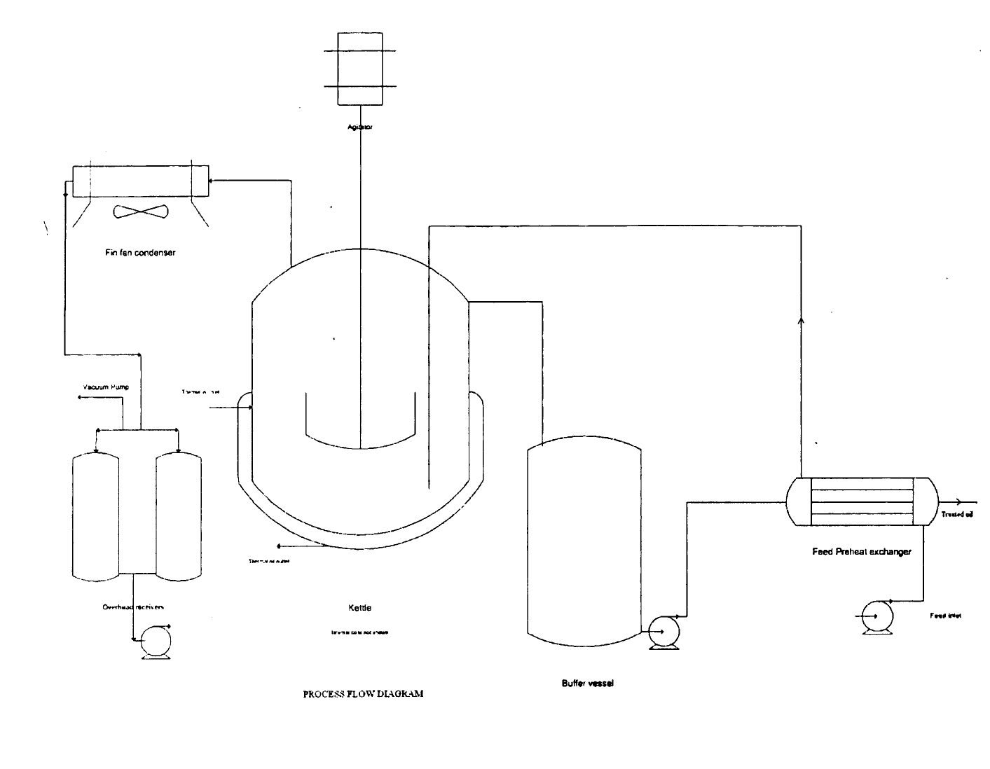

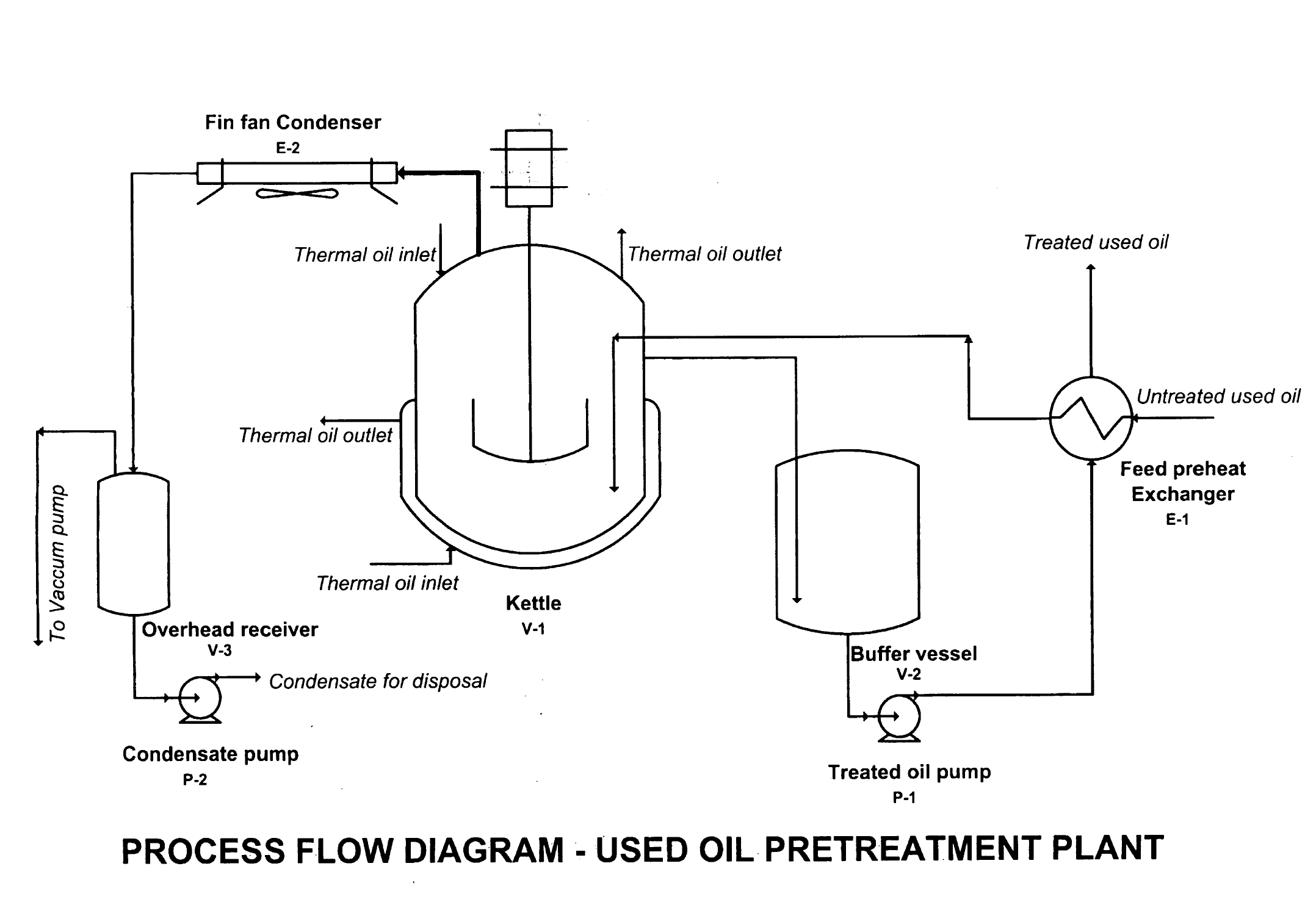

### DESCRIPTION

Commercially available units for used oil dehydration are following the simple process of heating and evaporation of the water vapors in large storage vessels. This not only causes nuisance to the public due to bad odor generated, but also not very effective in disintegrating the water formed as emulsion with used oil. Unilube's “Enhanced water removal from used oils” proves to be a low cost solution to handle water removal effectively without harming the environment.

### LEGEND

Feed oil means used oil with water.

Clean oil means oil with water less than 3%

Process oil means oil in reactor under water removal process.

### PROCESS DESCRIPTION

Feed oil having around 20% water (from various collection centers) is pumped through a feed/treated oil exchanger for preheating. The residual heat from the treated oil is utilized in this exchanger to preheat the feed oil.

Preheated Feed Oil (around 50° C.) is mixed with process oil in a reaction kettle and heated by means of indirect heating using hot thermic fluid. The kettle is designed to provide more heat transfer area by circulating thermic fluid inside limpet coil and submerged internal coil arrangement. Due to the inherent property of the contaminants in the used oil, the reaction kettle is provided with an agitator capable to maintain a uniform composition and prevent settling.

Moisture removal is accelerated by vacuum through column and condenser with the help of vacuum pump. Vacuum also enables system to control boiling temperature (105° C.). Vacuum assists positive flow path to distilled vapor.

Clean oil is then overflowed and collected in an intermediate/buffer vessel, where from it is pumped to oil pre-heater to exchange heat with feed oil, as explained earlier. And cold clean oil is stored in a separate vessel or tank for onward transportation to refinery.

Distilled vapor is condensed in a condenser and will be transferred to vacuum separator/receiver tank by gravity. Air-cooled condenser is employed to condense vapor.

### DETAILS

Used lube oils are reclaimed and recycled in the world to recover the valuable base oils. Such projects are gaining importance in the current world due to the increased awareness on environment protection induced oil recycling. These used lube oils have the following contaminants,

Water

Light ends—left over of fuel fraction

Ethylene glycol—left over anti-freeze

Solids

Metals

Our process acts as a pre-treatment step to dehydrate the oil before it is being transported to the refinery for re-refining.

The enclosed drawing gives the process flow diagram of the ‘Pre-treatment plant’ detailing the various major equipments and the process flow. This drawing is not drawn to scale. This process flow diagram is unique in design incorporating the most cost effective solution for the pre-treatment of used oils. The following are the salient features of this process:

The treated oil (@ around 90 Deg C.) is used to preheat the reaction kettle inlet feed oil in a feed/treated oil exchanger (E-1). This avoids unnecessary heat loss.

The reaction kettle (V-1) is designed to have complete agitation through blender type mixer installed vertically on the kettle. Mixing is the vital part of the used oil pre-treatment due to the uncertainty in the sources (no stringent quality control).

The feed enters through the bottom of the kettle and heated with constant agitation in the kettle using thermic fluid circulated in the internal coils and the limpet coils installed on the circumference of the kettle. The oil temperature of 100 to 105 Deg C. is sufficient to remove the water from the used oil from 20% in the feed to less than 3% in the treated oil. Treated oil overflows to the buffer vessel (V-2) (Designed to have maximum residence time and efficient water removal).

The heat input required for this process is limited and controlled by operating the kettle under vacuum (560 mm Hg A)

The vacuum created at the overhead vessels (V-3) pull the water vapors from the kettle through the condenser. Thus enabling recovery of water.

The condenser (E-2) is air-cooled fin fan type, designed specifically to avoid cooling tower requirements.

The plant is provided with a holding pond lagoon, wherein the condensed water is cooled by evaporation. The same water is utilized in the water ring vacuum pump. treatment unit' using this technology in Dammam (Saudi Arabia). Unilube has its own refinery for recovery of Base oils (Vaxon Technology). The yield % of base oils (Ratio of base oil recovered to the actual feed consumed) has improved from 45% to 55% upon commissioning of this pre-treatment unit. Untreated used oil with average water of 20% is treated to obtain treated oil with less than 3% water. The plant process flow can handle dirty used oil with cost effective recovery systems incorporated in the basic design.

What is claimed is:

1. This in-house designed process of enhanced water removal from used lube oils has proven successful for excessive water removal (20% to less than 3%) with the aid of vacuum. The operating cost of the unit is very low by incorporating heat recovery system in the basic design. Moreover the process limits the temperature to avoid cracking of high boilers thereby maintaining the properties of the valuable constituents of used oil. This pre-treatment step leads to increased yield of base oil in the downstream refinery.
